(19) United States
(12) Patent Application Publication
(10) Pub. No.: US 2017/0026110 A1
(43) Pub. Date: Jan. 26, 2017

(54) METHOD, APPARATUS AND SYSTEM FOR USE IN A SATELLITE BROADBAND INSTALLATION

(71) Applicant: Avanti Broadband Limited, London (GB)

(72) Inventors: Scott Richardson, Fromelles (FR); Carl Jonsson, London, Greater London (GB)

(73) Assignee: Avanti Broadband Limited, London (GB)

(21) Appl. No.: 15/124,846

(22) PCT Filed: Mar. 11, 2015
(86) PCT No.: PCT/EP2015/055107

§ 371 Date: Sep. 9, 2016

(30) Foreign Application Priority Data
Mar. 11, 2014 (GB) 1404248.5

(51) Int. Cl. H04B 7/185; H04L 29/08; H04L 12/26; H04W 4/02; H04W 24/10; H04W 4/14; H01Q 1/12

(52) U.S. Cl. CPC H04B 7/18578; H04W 4/14; H04L 67/34; H01Q 1/1257; H04B 7/18595; H04B 7/18517; H04W 4/026; H04W 4/02; H04W 4/027; H04W 24/10; H04L 43/045

(57) ABSTRACT

A method of an installer installing a satellite transceiver at a location of an customer, to provide internet access via a connection between said satellite transceiver and a satellite, the method comprising taking to said location a mobile device comprising a positioning module, an orientation module and signal strength measurement module all incorporated into said mobile device; and running an application on the mobile device which sets up said connection by using the positioning module of the mobile device to determine a position of the satellite transceiver, using the orientation module to align the satellite transceiver, and using the signal strength measurement module to determine the strength of said connection.

### TECHNICAL FIELD

The present invention relates to the installation of receivers for the provision of access to a network, in particular an internet, via a satellite connection.

### BACKGROUND

Some regions of the world such as rural, developing or isolated areas often have limited communication infrastructure where high speed broadband through traditional, ground-based (i.e. wired) means is not feasible. Providing an internet link via satellite enables such regions to obtain modern standards of internet access without the need to build a large amount of new infrastructure on the ground. Furthermore, satellite-based internet access can even be used as an alternative to ground-based links in regions that do have a developed communication infrastructure, or as backup to such infrastructure in case a ground-based link fails.

FIG. 1 gives a schematic overview of a system 100 for providing access to an internet 102, i.e. a wide area internetwork such as that commonly referred to as the Internet (capital I). The system 100 comprises a satellite gateway 104, a satellite 110 in orbit about the Earth, and one or more client systems 112 located in a region on the Earth's surface to which internet access is being provided. The satellite gateway 104 comprises a router 108 connected to the internet 102, and at least one satellite transceiver 106 connected to the router 108. Each of the one or more client systems also comprises a satellite transceiver 114. The satellite 110 is arranged to be able to communicate wirelessly with the transceiver 106 of the satellite gateway 104 and with the transceiver(s) 114 of the client system(s) 112, and thereby provide a link 107 for routing internet traffic between the source or destination on the internet 102 and the client system(s) 112. For example the satellite link 107 and transceivers 106, 114 may operate on the Ka microwave band (26.5 to 40 GHz).

In one model the operator of the satellite 110 and/or gateway 104 sells bandwidth to a downstream internet service provider (ISP), who in turn sells an internet access service based on that bandwidth to a plurality of end users 116. The end users 116 may be individual people (consumers) or businesses. Depending on implementation, the one or more client systems 112 may comprise a central satellite base station run by the ISP (the base station comprising the transceiver 114), and a local communication infrastructure providing access onwards to the equipment of a plurality of users within the region in question. E.g. the local communication infrastructure may comprise a relatively short range wireless technology (in comparison to GEO satellite distances) or a local wired infrastructure, connecting onwards to home or business routers or individual user terminals. Alternatively or additionally, the client systems 112 may comprise individual, private base stations each with its own satellite transceiver 114 for connecting to the satellite 110 and local access point for connecting to one or more respective user terminals. In this case the ISP does not necessarily provide any extra infrastructure, but acts as a broker for the bandwidth provided by the satellite 110. For example an individual femtocell or picocell could be located in each home or business, each connecting to a respective one or more user terminals using a short range wireless technology, e.g. a local RF technology such as Wi-Fi.

Referring to FIGS. 2 and 3 by way of example, the satellite 110 is deployed in a geostationary orbit and arranged so that its field of view or signal covers roughly a certain geographic region 200 on the Earth's surface. FIG. 2 shows South Africa as an example, but this could equally be any other country or region within any one or more countries (e.g. a state, county or province, or some other non-politically defined region). Using modern techniques the satellite 110 may be configured as a spot-beam satellite based on a beam-forming technology, so that the communications between the satellite 110 and the client equipment 112 in the covered region 200 are divided amongst a plurality of spatially distinct beams 202. In other arrangements, the satellite need not use spot-beam techniques. Also, satellites may be deployed in orbits other than a geostationary orbit. For example a constellation orbit arrangement may be used.

Installation of the client equipment 112 for receiving a satellite broadband signal, for example, a Ka band signal, involves accurate placement and alignment of the dish of the satellite transceiver 114.

Installation of a satellite dish requires that it is located at a particular set of coordinates to determine the required “look angle”, i.e. azimuth and elevation, towards the satellite. It must also be oriented correctly, i.e. at the correct azimuth and elevation, so that it can receive the satellite beam. To do this the installer uses an external GPS unit to determine location, a dedicated compass to determine azimuth and a dedicated inclinometer to ensure that the elevation of the dish is correct.

Installation of the transceiver 114 further involves measuring the strength of the satellite signal received at the client system to ensure that the dish has been aligned optimally. The installer uses a dedicated satellite meter to measure the strength of the satellite signal.

The connection between the client system 112 and the satellite 110 is configured by providing information to the client system to allow the client system to connect with the satellite gateway. The installer uses a laptop containing configuration software to configure the connection.

Once the satellite connection has been configured, the connection's performance is tested using testing software. The completion of the installation is then reported. To report complete installation, the installer takes a photo of the final installation site using a camera to demonstrate that no physical damage has been caused by the installation of the satellite dish. The installer also provides information to an operating server in order to provide confirmation that installation has been achieved. The installer may use the laptop to provide this information using the satellite connection.

As can be seen, a number of bulky items are required in order to complete the installation, which may make it more difficult for the installer to carry out his job correctly and safely. The number of items also introduces considerable expense to the initial setup of the installer. It would be desirable to provide a process for installation of a satellite transceiver at a local client which removed the requirement for a number of bulky items and simplified the process for the installer.

### SUMMARY

The present invention provides an application for a mobile device such as a smartphone or tablet which makes use of the orientation functionality and positioning system of the mobile device, instead of requiring the installer to take various different pieces of dedicated equipment to the customer's installation site.

According to an aspect, there is provided a method of an installer installing a satellite transceiver at a location of an customer, to provide internet access via a connection between said satellite transceiver and a satellite, the method comprising taking to said location a mobile device comprising a positioning module, an orientation module and signal strength measurement module all incorporated into said mobile device; and running an application on the mobile device which sets up said connection by using the positioning module of the mobile device to determine a position of the satellite transceiver, using the orientation module to align the satellite transceiver, and using the signal strength measurement module to determine the strength of said connection.

In embodiments, the method may comprise using a receiver of the mobile device to receive installation information, wherein the application configures the satellite transceiver using said installation information as part of said installation.

At least some of said installation information may be received via a cellular network, said receiver comprising a cellular receiver of the mobile device.

The method may comprise receiving at least some of the installation information via a short messaging service of the cellular network.

At least some of said installation information may be received by scanning a barcode or QR code to access the installation information, said receiver comprising a camera of the mobile device.

At least some of said installation information may be received by downloading the installation information from an internet server.

The positioning module may comprise a satellite receiver for determining the position from a satellite based positioning system.

The positioning module may comprise a cellular transceiver for determining the position relative to a plurality of base stations of the cellular network.

The orientation module may comprise a three-axis accelerometer.

The signal strength measurement module may comprise a portion of code run on the mobile device for determining the signal strength from the satellite transceiver being installed at the customer location via a connection between the mobile device and the satellite transceiver.

The application on the mobile device may indicate to the installer when the signal strength measurement module receives a signal above a threshold.

The application may prompt the installer with a sequence of instructions via a screen of the mobile device.

The application may cause the mobile device to issue a report of the installation once the connection has been set up.

The method may comprise using a camera of the mobile device to capture an image of said location to be sent as part of said report.

The method may comprise presenting a user interface on the mobile device independent of the local access point information.

The mobile device may be a phone or tablet.

In a further aspect there is provided an application comprising code embodied on a computer-readable medium and configured so as when executed on a mobile device to be operable to perform operations in accordance with the method above.

In a further aspect, there is provided a mobile device comprising the application above.

### BRIEF DESCRIPTION OF THE DRAWINGS

To assist understanding of the present disclosure and to show how embodiments may be put into effect, reference is made by way of example to the accompanying drawings in which:

FIG. 1 is a schematic diagram of a system for providing internet access via satellite,

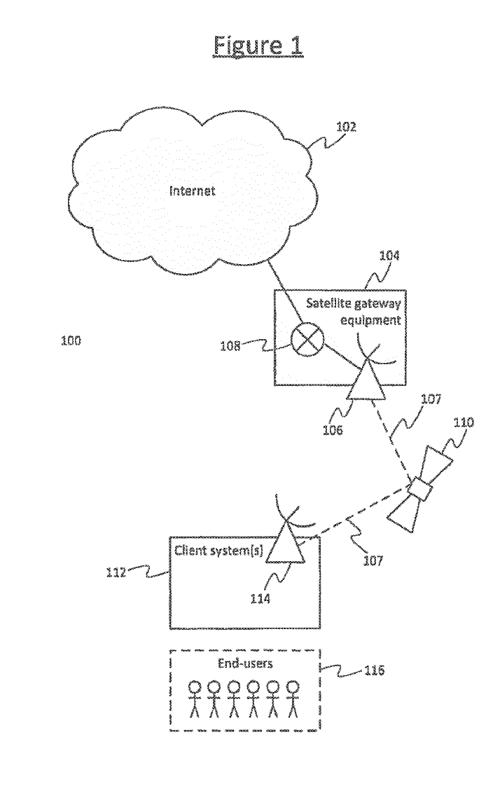

FIG. 2 is a schematic diagram showing geographic coverage of a cluster of satellite beams,

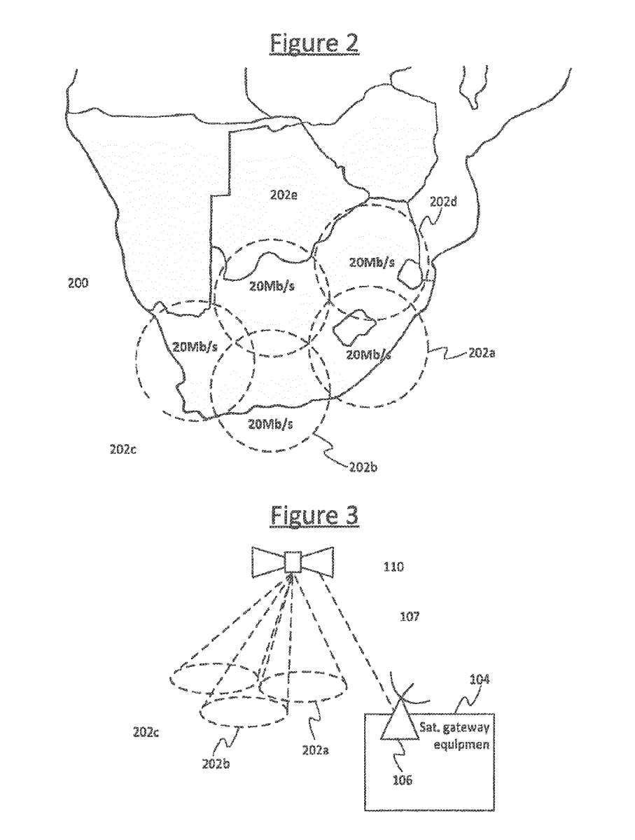

FIG. 3 is a schematic diagram of a part of a system for providing internet access via satellite beams,

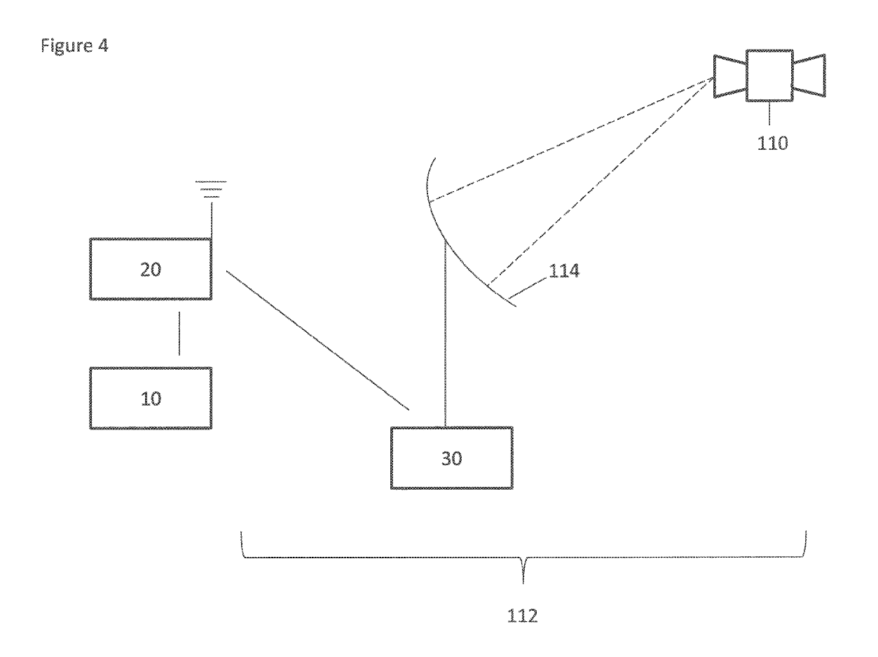

FIG. 4 is a schematic diagram of a network for use in installing a satellite transceiver,

FIG. 5 is a schematic diagram of a mobile device for use in installing a satellite transceiver,

FIG. 6 is a flow chart showing a method for installing a satellite broadband receiver, FIG. 7 shows a screen shot of a mobile device implementing an application for use in installing a satellite transceiver, and

FIG. 8 shows a screen shot of an application for use in installing a satellite transceiver.

### DETAILED DESCRIPTION

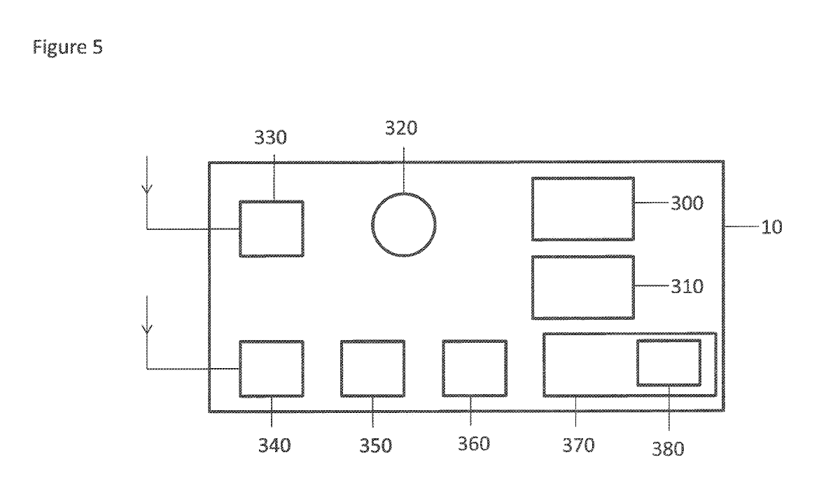

A system as shown in FIG. 4 is provided for an installer to use when installing a satellite transceiver 114 at the location of a customer (e.g. an end-user's home or office, or other site or complex such as a shop, school, hospital, or the site of a village or community LAN etc). The system comprises a mobile device 10, such as a smartphone or tablet; and a wireless access point 20, such as a home or office router operating based on a short-range wireless access technology such as Wi-Fi or Zigbee. The mobile device 10 belongs to the installer (or his or her employer) and is brought by the installer to the customer location. The wireless access point 20 may already be present at the customer's installation site, or may be brought by the installer. The mobile device 10 is configured to run an application which makes use of the inclinometer functionality, positioning system and networking functionality incorporated in the mobile device 10 to position and align the dish of a satellite transceiver 114. The mobile device 10 is connectable to the wireless access point 20.

The client system 112 comprises the satellite transceiver 114 and a satellite modem 30. The satellite modem 30 is connected to the satellite transceiver 114 and receives satellite signals therefrom. The wireless access point 20 is connectable to the satellite modem. The satellite modem 30 may be a home satellite hub or connect to a Local Area Network (LAN) to provide onwards access to a community or organisation such as a village, campus, company site or hospital. After the satellite transceiver 114 has been installed by the installer, the user connects one or more user terminals to the satellite modem 30 via the wireless access point 20. The user terminals are then able to access the internet using the satellite broadband signal.

The installer connects the mobile device 10 to the satellite modem 30 at the installation location via the wireless access point 20. The mobile device 10 is thus connected to the satellite transceiver 114 via the satellite modem 30 and wireless access point 20, via the relevant wireless access technology of the wireless access point 20 (e.g. home or office router).

Alternatively the satellite modem 30 may itself be capable of establishing a connection to the mobile device 10 and/or to a user terminal directly. In this case a separate wireless access 20 point is unnecessary. The connection between the satellite modem 30 and user terminals may be wireless or wired.

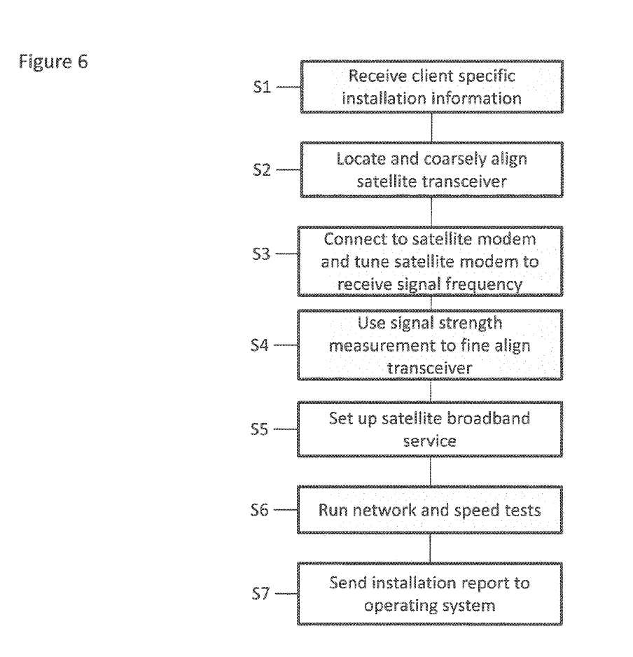

FIG. 5 shows a mobile device 10 which may be used in embodiments of the present invention. The mobile device 10 may be a smartphone or a tablet. The mobile device 10 comprises a display screen 300, a user interface 310, an image capturing device 320, a satellite receiver 330 (e.g. GPS receiver) and a cellular transceiver 340. The mobile device also comprises a positioning module 350, a signal strength measuring module 360 and an orientation module 370. The modules may comprise hardware, software or a combination thereof.

For example, in embodiments the orientation module 370 may comprise a three-axis accelerometer of the mobile device 10, or other tilt sensor, in combination with suitable code running on the mobile device 10. The orientation module 370 also comprises a compass module 380 which, in combination with suitable code running on the mobile device, can determine orientation of the mobile device 10.

The positioning module 350 may comprise a combination of the satellite receiver 330 and a portion of code running on the installer's mobile device 10, configured to determine the location of the mobile device 10 from a satellite based positioning system such as GPS, GLONASS or Galileo, making use of signals received from the satellite receiver 330 to determine the position of the mobile device. Alternatively, the positioning module may use cellular signals received at the cellular transceiver 340 based on a technique such as triangulation, trilateration or multilateration to determine the position of the mobile device 10 relative to a plurality of base stations of the cellular network.

The signal strength measurement module 360 may be a software component which measures the signal received at the satellite transceiver or it may be a dedicated hardware component in the mobile device. E.g. the signal strength measurement module 360 may comprise only a portion of code running on the mobile device 10, configured to determine the signal strength from the satellite transceiver 114 via the connection with the satellite modem 30 (and wireless access point 20). In this example, the satellite transceiver 114 measures the signal it receives. Satellite transceivers 114 are non-standard across vendors, and the signal strength measurement module 360 comprises software which abstracts the value obtained from the transceiver 114 into a value comparable with a predetermined target value. Alternatively the signal strength measurement module 360 may comprise a satellite receiver on the mobile device 10 itself.

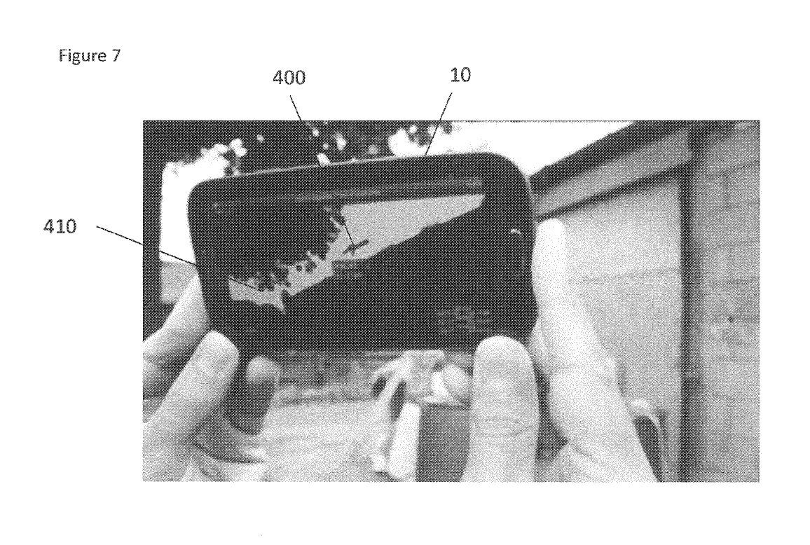

The mobile device 10 is configured to run the code of an application for installing a satellite transceiver 114 at a client site. The application causes the installer's mobile device 10 to perform the method as shown in FIG. 6 to facilitate installation of a satellite transceiver 114 at a client site.

At step S1, the mobile device 10 receives client specific installation information from an operating server at a back office. For example, the installation information may comprise a job identity, job location (e.g. rough location of installation such as an address), receive signal frequency, and/or information allowing the satellite to be located relative to the earth, e.g. the azimuth and elevation of the satellite relative to the earth. The installation data may be received via a cellular network and the cellular transceiver 340 of the mobile device (for example, but not limited to, using a 2G, 3G or LTE wireless access technology). For example this may be received in a short text string using, e.g., a short messaging service (SMS) which is received by the cellular transceiver, or may be received on a packet data channel of the cellular network. Alternatively or additionally, some or all of the installation data may be acquired using a one or two dimensional barcode such as a QR code which is scanned using the image capturing device 320 of the mobile device. The QR code may comprise code which directs the installer to a portal from which he can download client specific installation information. Alternatively, the QR code may comprise the installation information directly.

Alternately or additionally, the mobile device 10 may receive some or all of the installation information prior to arriving on site, i.e. the job location. That is, the installer may download the information before he arrives on site directly from the operating server. In this case the installer does not require a phone signal or an internet connection at the client site to obtain installation information once he is on site and prior to the satellite transceiver 114 being installed.

At step S2, the installer then then uses the positioning module 350 and orientation module 350 of the device 10, along with the satellite location information as received in step S1, to coarsely align the satellite of the satellite transceiver 114. The positioning module 350 acts to determine a geographical location of the satellite transceiver 114. From the satellite location information received in step S1 and the current location of the satellite transceiver 114 provided by the positioning module 350, the application can calculate the position of the satellite in the sky at the current location, and hence the azimuth and elevation to which the dish of the satellite transceiver 114 must be aligned. Elevation refers to the angle between the beam pointing direction, directly towards the satellite, and the local horizontal plane. Azimuth refers to the rotation of the whole antenna around a vertical axis.

In embodiments, in order to ensure that a line of sight to the satellite from the satellite transceiver is present, the mobile device 10 may comprise software which causes the mobile device 10 to display to the installer a visual representation 400 of the location of the satellite 112 over a real time captured image 410, based on the position of the satellite in the sky and the orientation of the mobile device 10 as measured by the orientation module. This is known as augmented reality. As shown in FIG. 7, the augmented reality function visually displays to the user when an appropriate line of sight is present. The augmented reality function may be used to coarsely orient the satellite dish towards the satellite beam.

Alternatively or in addition, the orientation module 370 acts as an inclinometer allowing the installer to determine the elevation setting of the dish of the satellite transceiver 114. The installer may use the mobile device 10 like a spirit level to measure the elevation of the dish or, the application on the mobile device 10 may display the required elevation to the installer who then estimates visually the required position of the dish. The compass module 380 of the orientation module 370 allows the installer to determine the correct azimuth of the dish. The installer may use the mobile device to measure the direction of the dish, or he may use the mobile device 10 to provide him with the information from which he can position the dish coarsely. As a result, the bulky equipment such as an inclinometer, compass and GPS unit are not required since their functionality is achieved using the mobile device 10.

At step S3, the mobile device 10 then connects to the satellite modem 30, either via the wireless access point 20 or directly. The satellite modem 30 receives at least some of the initial configuration information as obtained in step S1 from the mobile device 10. In particular, the satellite modem receives information indicative of the receive signal frequency as obtained in step S1 so that is able to detect the satellite signal. The satellite modem 30 is then tuned to the satellite signal frequency, received as part of the initial configuration information and connects to the satellite network.

At step S4, the mobile device 10 uses the signal strength measurement module 360 to further, finely, align the dish of the satellite transceiver 114. The signal strength measurement module 360 monitors signal strength received at the satellite modem 30, at the frequency provided in step S3, as the alignment of the dish is changed. Once the signal strength reaches a predetermined threshold, the mobile device 10 indicates to the user that the dish is oriented correctly. The mobile device 10 may audibly indicate that the threshold has been reached, or may provide a visual indication.

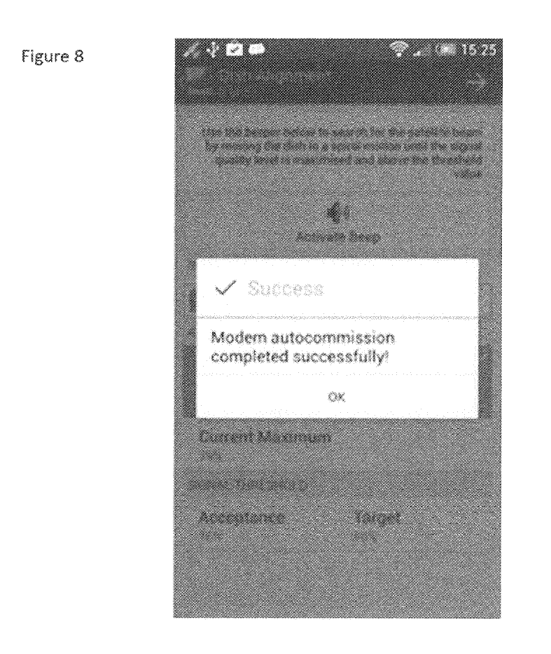

At step S5, the mobile device 10 is then used to set up the satellite broadband service. Set up requires the protocol stack above the physical layer. Once the transceiver 114 is receiving a signal of a sufficient strength, the application causes the satellite modem 30 to automatically set up access to the satellite broadband service. In embodiments, the satellite modem is pre-installed with software which is capable of setting up the service. The satellite modem 30 may use the newly established connection to download additional software such as software updates from the satellite gateway via the satellite link. Setting up of the service is vendor specific, i.e., specific to the vendor satellite transceiver. The download of software, and subsequent set up of the service, may take place automatically when the detected signal has reached a threshold value. Alternatively, the mobile device 10 may display a prompt to the installer. The installer then uses the user interface to instruct the mobile device 10 to begin the set up process. As shown in FIG. 8, the application may cause the mobile device 10 to indicate to the user when the service has been activated.

Once the service has been activated, at step S6 the application in the mobile device 10 is configured to run tests to determine network and speed. The test may be run manually and involve an installer instructing a mobile device 10 to begin the test, optionally, in response to a prompt from the mobile device 10. Alternatively, the tests may run automatically once the service has been commissioned.

At step S7, the mobile device 10 then sends an installation report to the operating server.

The installer may receive a prompt from the mobile device 10 to complete an installation report. In embodiments completing the installation report involves taking a photograph of the site using the image capturing module, to evidence that the job has been done and/or that no damage has been caused in the installation. Alternatively or additionally the network and/or speed test results may also be incorporated into the installation report. The job report may be identified using the job identity. Once the report is completed, it may be sent automatically to the operating system via the satellite connection. Alternatively, the report is stored and then forwarded when cellular network connectivity with the “back office system” (operating server) is available or when connection to another network is available, e.g. a local wireless or wired connection. That could be immediately at the point of installation or deferred if necessary. The application then causes the mobile device 10 to display a prompt to the user indicating that the installation process is complete.

Using a mobile device 10 such as a smartphone to complete the installation process negates the requirement for multiple pieces of equipment to install the satellite dish, by exploiting the presence of various types of sensor or receiver already incorporated into many modern mobile devices. The functionality of the inclinometer, compass, GPS, phone, internet connection and instructions are implemented in a single device, simplifying the tools required to install a satellite for receiving a broadband signal and as a result, the overall process. The installer requires only a mobile device 10 and a wireless access point 20 to install the dish to the required standard. If the modem 30 in situ has the capability to connect to the smartphone, then the wireless router is not required. The application causes the mobile device 10 to provide prompts to the installer of the transceiver to ensure that steps of the method are not omitted.

In addition, in embodiments the process for installation is made vendor agnostic so that a downstream internet provider may undertake the installation procedure regardless of vendor. The satellite modem 30 to which the satellite transceiver is connected may be provided by a variety of different vendors. As a result, the interfaces which are presented to the mobile device 10 and the requirements for configuration will vary. If the vendors make the application programming interface (API) for the satellite modem 30 available, the application may be configured with the relevant API(s) of one or more such vendors, and is thereby interoperable with the vendor's satellite modems and appears the same to the installer regardless of which vendor supplies the modem. If an API is not available for a particular vendor on the other hand, the application may be configured to extract data from the access point in a process known as “screen scraping” so that the application is configured to present a display to the user which is constant regardless of the vendor access point. Screen scraping involves software which extracts data from another program, the data being intended for display to an end user. The satellite modem 30 has in it software designed to provide a user interface through a browser of a device connected to it. Using screen scraping however, the vendor-agnostic installation application on the mobile device 10 intercepts data from the satellite modem 30 intended for the user interface, and converts it for used by the installation application and/or for display to the installer within the interface of the application. The application could also be configured with a combination of APIs and screen scraping for different vendors depending on whether they make their APIs available.

Furthermore, in embodiments the application comprises a “wizard” to make the installation process as simple as possible for the installer. That is, the application is configured to automatically prompt the installer step-by-step through some or all of the steps described above. Any of the steps S1 to S8 may be performed automatically. Some of the steps may be hidden through automation. The steps may be performed completely automatically, without installer input, or the installer may receiver a prompt to which he must respond to confirm the action to be taken, or perform a physical task such as aligning the satellite dish or taking a photograph of the installation site.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. For instance, although the above method is described with regard to fixed satellite services, which are geostationary, it could be used to initiate the installation of a service delivered using a constellation of MEO or LEO satellites where tracking antennae are used. Such and similar modifications of the teachings of this invention will still fall within the scope of this invention as defined in the appended claims. Further embodiments may comprise features from one embodiment in combination with a feature or features from any of the other embodiments previously discussed.

1. A method of an installer installing a satellite transceiver at a location of an customer, to provide internet access via a connection between said satellite transceiver and a satellite, the method comprising:
taking to said location a mobile device comprising a positioning module, an orientation module and signal strength measurement module all incorporated into said mobile device; and
running an application on the mobile device which sets up said connection by using the positioning module of the mobile device to determine a position of the satellite transceiver, using the orientation module to align the satellite transceiver, and using the signal strength measurement module to determine the strength of said connection.

2. The method according to claim 1, comprising using a receiver of the mobile device to receive installation information, wherein the application configures the satellite transceiver using said installation information as part of said installation.

3. The method according to claim 2, wherein at least some of said installation information is received via a cellular network, said receiver comprising a cellular receiver of the mobile device.

4. The method according to claim 3, comprising receiving at least some of the installation information via a short messaging service of the cellular network.

5. The method according to any of claims 2 to 4, wherein at least some of said installation information is received by scanning a barcode or QR code to access the installation information, said receiver comprising a camera of the mobile device.

6. The method according to any of claims 2 to 5, wherein at least some of said installation information is received by downloading the installation information from an internet server.

7. The method according to any preceding claim wherein the positioning module comprises a satellite receiver for determining the position from a satellite based positioning system.

8. The method according to any preceding claim, wherein the positioning module comprises a cellular transceiver for determining the position relative to a plurality of base stations of the cellular network.

9. The method according to any one of the preceding claims, wherein the orientation module comprises a three-axis accelerometer.

10. The method of any preceding claim, wherein the signal strength measurement module comprises a portion of code run on the mobile device for determining the signal strength from the satellite transceiver being installed at the customer location via a connection between the mobile device and the satellite transceiver.

11. The method according to any preceding claim, wherein the application on the mobile device indicates to the installer when the signal strength measurement module receives a signal above a threshold.

12. The method according to any preceding claim, wherein the application prompts the installer with a sequence of instructions via a screen of the mobile device.

13. The method according to any preceding claim, wherein the application causes the mobile device to issue a report of the installation once the connection has been set up.

14. The method according to claim 13, comprising using a camera of the mobile device to capture an image of said location to be sent as part of said report.

15. A method according to any preceding claim comprising presenting a user interface on the mobile device independent of the local access point information.

16. A method according to any preceding claim, wherein the mobile device is a phone or tablet.

17. An application comprising code embodied on a computer-readable medium and configured so as when executed on a mobile device to be operable to perform operations in accordance with the application of any of claims 1 to 16.

18. A mobile device comprising the application of claim 17.
